(19) United States
(12) Patent Application Publication
(10) Pub. No.: US 2018/0363761 A1
(43) Pub. Date: Dec. 20, 2018

(54) HYBRID OIL PUMP

(71) Applicant: PIERBURG-PUMP TECHNOLOGY GMBH, NEUSS (DE)

(72) Inventors: MARCO PARISI, NAPOLI (IT); ALESSANDRO MALVASI, LIVORNO (IT); VLADIMIR POPOV, VILLINGEN-SCHWENNINGEN (DE)

(73) Assignee: PIERBURG-PUMP TECHNOLOGY GMBH, NEUSS (DE)

(21) Appl. No.: 16/060,956

(22) PCT Filed: Apr. 7, 2016
(86) PCT No.: PCT/EP2016/057557

§ 371 Date: Jun. 11, 2018

(30) Foreign Application Priority Data
Dec. 14, 2015 (EP) PCT/EP2015/079561

(51) Int. Cl. F16H 57/04; F16H 61/00

(52) U.S. Cl. CPC F16H 57/0439; F16H 61/0028

(57) ABSTRACT

A hybrid oil pump for a vehicle with an engine. The hybrid oil pump includes an oil pump unit which pumps a pressurized oil to a vehicle component, a mechanical drive which drives the oil pump unit in a mechanical driving mode, an electrical drive which drives the oil pump unit in an electrical driving mode, and a freewheel clutch which automatically couples the mechanical drive with a pump shaft when a rotational speed of the mechanical drive is higher than a rotational speed of the synchronous reluctance motor. The mechanical drive is mechanically connected to and driven by the engine. The electrical drive includes a synchronous reluctance motor which is directly mechanically connected to the oil pump unit.

### CROSS REFERENCE TO PRIOR APPLICATIONS

This application is a U.S. National Phase application under 35 U.S.C. § 371 of International Application No. PCT/EP2016/057557, filed on Apr. 7, 2016 and which claims benefit to European Patent Application No. PCT/EP2015/079561, filed on Dec. 14, 2015. The International Application was published in English on Jun. 22, 2017 as WO 2017/102101 A1 under PCT Article 21(2).

### FIELD

The present invention relates to a hybrid oil pump for a vehicle comprising an engine for driving the vehicle, for example, an internal combustion engine or an electrical engine.

### BACKGROUND

A typical example for the use of a hybrid oil pump is to provide oil pressure even when the internal combustion engine is not running, for example, when the engine stops for some seconds in a start/stop modus or is in a sailing modus. When the engine is stopped, the pressurized oil is used, for example, to pre-lubricate, for example, the bearings, to post-lubricate, for example, cooling and lubricating a turbine, and for maintaining the oil pressure in other hydraulic devices, for example, in a hydraulic cam-phaser. The pressurized oil is also used to maintain the oil pressure in the clutches of an automotive gearbox.

The hybrid oil pump comprises an oil pump unit for pumping pressurized oil to a vehicle component. The oil pump is provided with a mechanical drive for driving the oil pump unit in a mechanical driving mode, wherein the mechanical drive is mechanically connected to and driven by the engine. The oil pump is also provided with an electrical drive for driving the pump unit in an electrical driving mode when the engine is not rotating but when the oil pump still needs to be active.

### SUMMARY

An aspect of the present invention is to provide a hybrid oil pump having a simple construction and an improved efficiency.

In an embodiment, the present invention provides a hybrid oil pump for a vehicle comprising an engine. The hybrid oil pump includes an oil pump unit configured to pump a pressurized oil to a vehicle component, a mechanical drive configured to drive the oil pump unit in a mechanical driving mode, an electrical drive configured to drive the oil pump unit in an electrical driving mode, and a freewheel clutch configured to automatically couple the mechanical drive with a pump shaft when a rotational speed of the mechanical drive is higher than a rotational speed of the synchronous reluctance motor. The mechanical drive is mechanically connected to and driven by the engine. The electrical drive comprises a synchronous reluctance motor which is directly mechanically connected to the oil pump unit.

### BRIEF DESCRIPTION OF THE DRAWINGS

The present invention is described in greater detail below on the basis of embodiments and of the drawings in which:

FIG. 1 shows a schematic drawing of a hybrid oil pump according to an embodiment of the present invention;

FIG. 2 shows a cross section of a first embodiment of a freewheel clutch; and

FIG. 3 shows a cross section of a second embodiment of a freewheel clutch.

### DETAILED DESCRIPTION

The hybrid oil pump is provided with an oil pump unit for pumping pressurized oil to a vehicle component. A vehicle component as used herein means, for example, the gearbox, the internal combustion engine, the steering unit or heat exchangers. The hybrid oil pump is provided with a mechanical drive for driving the pump unit in a mechanical driving mode and with an electrical drive for driving the pump unit in an electrical driving mode. The mechanical drive is driven by the engine. This engine can, for example, be an internal combustion engine. The electrical drive is a synchronous reluctance motor. The hybrid oil pump is provided with a freewheel clutch arranged between the mechanical drive and the electrical drive. The freewheel clutch according to the present invention is designed so that the mechanical drive is automatically coupled with a pump shaft of the pump unit when the rotational speed of the mechanical drive is higher than the rotational speed of the synchronous reluctance motor.

No permanent magnets are used in a synchronous reluctance motor so that no magnetic forces are generated when the stator coils of the motor are not energized. The rotor of the synchronous reluctance motor is rotated by the mechanical drive when the freewheel clutch couples the mechanical drive with the pump unit. The stator coils of the synchronous reluctance motor are switched off in this case so that no magnetic resistance torque is generated when the synchronous reluctance motor is dragged.

Because the synchronous reluctance motor is dragged by the mechanical drive without generating magnetic losses, a sophisticated clutch, for example, a switchable disc-clutch for decoupling the electrical drive, is not necessary. A very simple and reliable freewheel clutch is instead used so that the number of parts of the pump unit compared to a pump unit using a disc-clutch is decreased. The pump unit can accordingly be manufactured more economically. Because a failure of a complex disc-clutch cannot occur, the pump unit can also be made to be more fully fail-safe.

In an embodiment of the present invention, a motor shaft of the synchronous reluctance motor can, for example, be provided to co-rotate with the pump shaft. The motor shaft is directly mechanically and stiffly connected to the pump shaft. With this arrangement, the motor rotor also rotates when the mechanical drive drives the pump. This has the advantage that the hybrid oil pump has a compact design.

In an embodiment of the present invention, the mechanical drive can, for example, comprise a pulley wheel which is driven by a belt. In an alternative embodiment of the present invention, the mechanical drive can, for example, comprise a sprocket wheel instead of the pulley wheel, the sprocket wheel being driven by a chain which is driven by the engine. Compared to a pulley wheel, a sprocket wheel has the advantage that slip between the chain and the sprocket is avoided.

A pulley arrangement can, for example, be provided, which comprises the freewheel clutch and the pulley wheel. The freewheel clutch forms a hub of the pulley wheel. The inner race of the freewheel clutch is mechanically connected to the pump shaft. Because the freewheel clutch and the pulley wheel are provided as a single part, no further axial space is needed to accommodate the freewheel clutch. The required space for the mechanical drive can accordingly be reduced.

In an embodiment of the present invention, a sprocket arrangement can, for example, be provided which comprises the freewheel clutch and the sprocket wheel. The sprocket arrangement is thereby provided so that the freewheel clutch forms a hub of the sprocket wheel. The inner race of the freewheel clutch is mechanically connected to the pump shaft. As with the pulley arrangement, the sprocket arrangement also has the advantage that space for the mechanical drive can be reduced.

In an embodiment of the present invention, the freewheel clutch can, for example, comprise an outer race having sawtooth depressions at its inner circumferential surface. The freewheel clutch further comprises an inner race, which is provided within the outer race, so as to be rotatable in one rotational direction with respect to the outer race. The inner race can, for example, comprise at least one, for example, four pawls, extending on an outer circumferential surface thereof. The pawl(s) are thereby provided to interact with the sawtooth depressions to block one rotational direction of the inner race with respect to the outer race.

In an embodiment of the present invention, the pawl(s) can, for example, be mechanically preloaded in a radial direction via a spring so that one end of a pawl is in a permanent contact with the sawtooth depressions so as to block one rotational direction of the inner race with respect to the outer race. A spiral spring or a leaf spring can, for example, be used as a spring. A leaf spring has the advantage that it can be easily and thus economically manufactured. In an embodiment of the present invention, a pawl itself can, for example, be made out of a resilient material.

The freewheel clutch with the arrangement of the pawls extending the inner race additionally has the advantage that it is fail-safe. In case of a failure of the springs preloading the free ends of the pawls in a radial direction, the free ends will be forced in the direction to the sawtooth depressions by centrifugal force generated by rotation of the inner race. When the internal combustion engine again restarts, the rotational speed of the outer race becomes faster than the rotational speed of the inner race. Because the free ends of the pawls are in contact with the sawtooth depressions due to the centrifugal force, the other rotational direction of the inner race relative to the outer race is blocked. The inner race accordingly co-rotates with the outer race. When the inner race co-rotates with the outer race, the free ends of the pawls lock with the respective sawtooth depressions. By co-rotating the inner race with the outer race, the free ends will still be forced in the direction to the sawtooth depressions by the centrifugal force generated by the co-rotation of the inner race. The coils of the electrical drive can be switched off.

A detailed description of an embodiment of the present invention is set forth below under reference to the drawings.

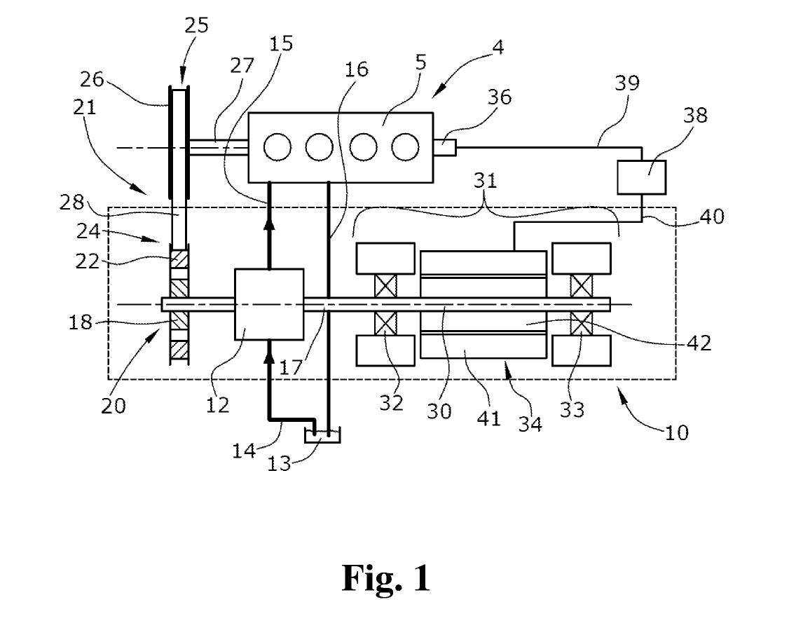

FIG. 1 shows a schematic representation of an arrangement 4 comprising a vehicle driving engine 5 and a hybrid oil pump 10. According to the described embodiment, the vehicle driving engine 5 is, for example, an internal combustion engine. The hybrid oil pump 10 comprises an oil pump unit 12 which pumps oil from an oil sink 13 to a vehicle component via an oil sink conduit 14 and an oil delivery conduit 15. The vehicle component according to the described embodiment is, for example, the internal combustion engine 5. The oil from the internal combustion engine 5 is discharged to the oil sink 13 by an oil discharge conduit 16.

A pump rotor of the oil pump unit 12 is mechanically fixed to a pump shaft 17. One axial end of the pump shaft 17 is fixed to an inner race 18 of a freewheel clutch 20 of a driving arrangement 21. The freewheel clutch 20 further comprises an outer race 22, which is also defined by a pulley wheel 24. The inner race 18 is provided within the outer race 22 so as to be rotatable in one rotational direction relative to the outer race 22. In the other relative rotational direction of the inner race 18 with respect to the outer race 22, the outer race 22 blocks a relative rotation of the inner race 18 so that the inner race 18 co-rotates with the outer race 22.

The internal combustion engine 5 mechanically drives a mechanical drive 25. The mechanical drive 25 comprises the pulley wheel 24 and an engine driving wheel 26, which is driven by the internal combustion engine 5 via an engine shaft 27. The engine driving wheel 26 is mechanically connected to the pulley wheel 24, comprising the freewheel clutch 20, via a belt 28. The pump unit 12 is therefore mechanically connected and driven by the internal combustion engine 5.

The other axial end of the pump shaft 17 is mechanically connected to an end of a motor shaft 30 of an electrical drive 31 mechanically driving the pump unit 12. The electrical drive 31 comprises bearings 32, 33 supporting the motor shaft 30. The electrical drive 31 further comprises a reluctance motor 34, which is always mechanically directly connected to the axial end of the pump shaft 17.

When the internal combustion engine 5 is in a stop mode, the oil pump unit 12 is not further mechanically driven by the internal combustion engine 5. In this case, a temperature sensor 36 detects the temperature of the internal combustion engine 5 and forwards a temperature signal to an electronic control device 38 via an electric signal conduit 39. If the temperature exceeds a predetermined value, the electronic control device 38, which is also connected to the reluctance motor 34 via an electric conduit 40, starts the reluctance motor 34 by energizing magnetic coils 41. The reluctance motor 34 then drives the oil pump unit 12 so that pressurized oil is forwarded to the internal combustion engine 5 and the temperature of the internal combustion engine 5 is decreased. The inner race 18 then rotates with respect to the outer race 22 in a direction which is not blocked. When the internal combustion engine 5 again restarts, the rotational speed of the outer race 22 becomes faster than the rotational speed of the inner race 18. As the other rotational direction of the inner race 18 relative to the outer race 22 is blocked, the inner race 18 co-rotates with the outer race 22. The electronic control device 38 switches off the reluctance motor 34 if no cooling of the internal combustion engine 5 is needed or if the internal combustion engine 5 is running. A rotor 42 of the reluctance motor 34 therefore co-rotates with the pump shaft 17 without generating any magnetic losses.

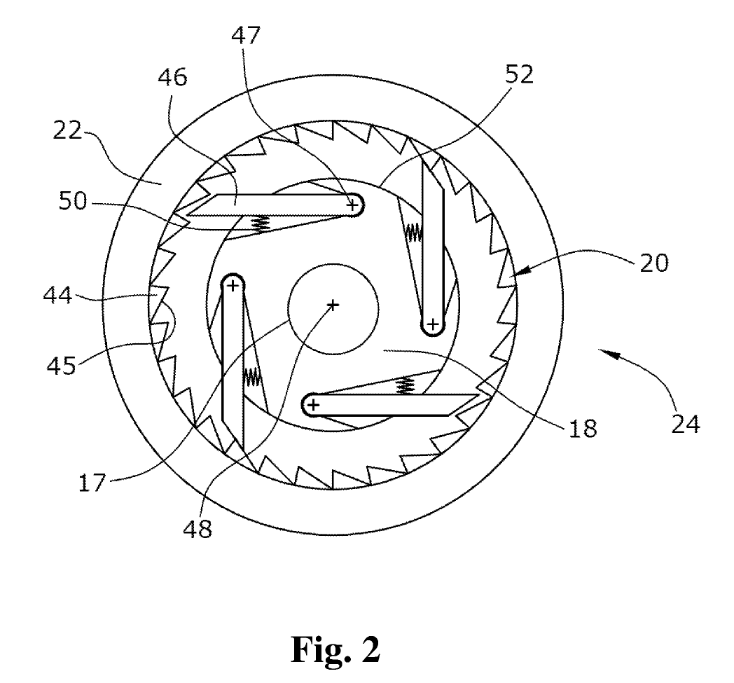

FIG. 2 shows a cross section of a first embodiment of a freewheel clutch 20 with the outer race 22 having sawtooth depressions 44 at its inner circumferential surface 45. In this embodiment of the present invention, the outer race 22 is mechanically fixed at the pulley wheel 24.

The inner race 18 is arranged within outer race 22. The inner race 18 is thereby provided to be rotatable in one direction with respect to the outer race 22. The inner race 18 comprises four pawls 46, the first ends of which are fixed at the inner race 18 so as to allow a rotation around a rotation axis 47 parallel to a rotation axis 48 of the inner race 18. The pawls 46 are preloaded by a spiral spring 50 in a radially outward direction so that the pawls 46 extend outwardly from an outer circumferential surface 52 of the inner race 18. The pawls 46 are preloaded so as to be in permanent contact with the sawtooth depressions 44 of the outer race 22.

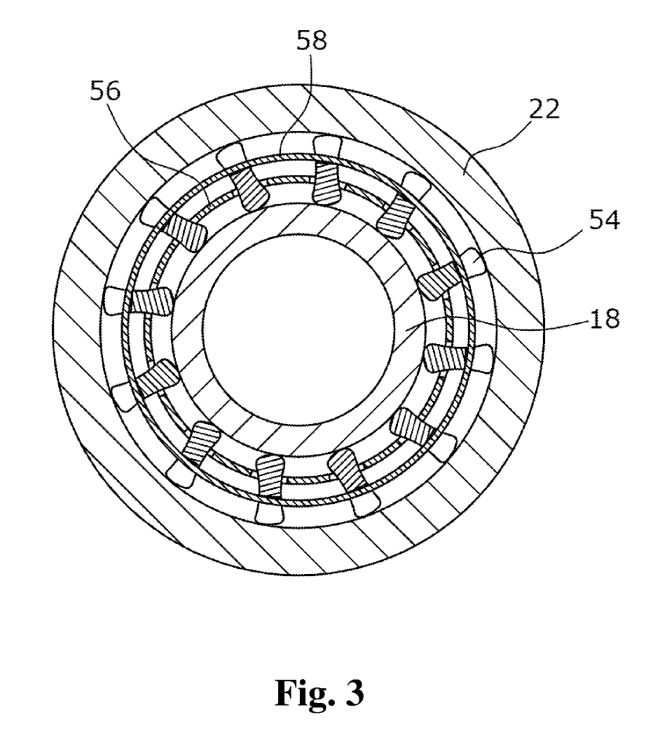

FIG. 3 shows a cross section of a second embodiment of a freewheel clutch 20 providing a plurality of sprag portions 54 arranged between the inner race 18 and the outer race 22. The sprag portions 54 are tiltably provided in a cage 56 so as to allow a relative rotation of the inner race 18 with respect to the outer race 22 in one rotational direction and to block the other rotational direction. A spring ring 58 pretensions the sprag portions 54 to a radial inner direction.

The present invention is not limited to the above described embodiments. An electrical engine can in particular be used to drive the mechanical drive instead of the internal combustion engine. Instead of the internal combustion engine, the oil pump unit can also pump pressurized oil to vehicle components such as, for example, the transmission, the gearbox, the steering unit or heat exchangers. Reference should also be had to the appended claims.

### REFERENCE SIGNS

4 arrangement
5 vehicle driving engine/internal combustion engine
10 hybrid oil pump
12 oil pump unit
13 oil sink
14 oil sink conduit
15 oil delivery conduit
16 oil discharge conduit
17 pump shaft
18 inner race
20 freewheel clutch
21 driving arrangement
22 outer race
24 pulley wheel
25 mechanical drive
26 engine driving wheel
27 engine shaft
28 belt
30 motor shaft
31 electrical drive
32 bearing
33 bearing
34 reluctance motor
36 temperature sensor
38 electronic control device
39 electric signal conduit
40 electric conduit
41 magnetic coil(s)
42 rotor
44 sawtooth depression
45 inner circumferential surface
46 pawl(s)
47 rotation axis (of pawls)
48 rotation axis (of the inner race)
50 spiral spring
52 outer circumferential surface
54 sprag portions
56 cage
58 spring ring

What is claimed is:

1-6. (canceled)

7. A hybrid oil pump for a vehicle comprising an engine, the hybrid oil pump comprising:
an oil pump unit configured to pump a pressurized oil to a vehicle component;
a mechanical drive configured to drive the oil pump unit in a mechanical driving mode, the mechanical drive being mechanically connected to and driven by the engine;
an electrical drive configured to drive the oil pump unit in an electrical driving mode, the electrical drive comprising a synchronous reluctance motor which is directly mechanically connected to the oil pump unit; and
a freewheel clutch configured to automatically couple the mechanical drive with a pump shaft when a rotational speed of the mechanical drive is higher than a rotational speed of the synchronous reluctance motor.

8. The hybrid oil pump as recited in claim 7, wherein
the synchronous reluctance motor comprises a motor shaft, and
the motor shaft is configured to co-rotate with the pump shaft.

9. The hybrid oil pump as recited in claim 7, further comprising:
a chain,
wherein,
the mechanical drive comprises a sprocket wheel which is configured to be driven by the chain.

10. The hybrid oil pump as recited in claim 9, further comprising:
a sprocket arrangement which comprises the freewheel clutch and the sprocket wheel.

11. The hybrid oil pump as recited in claim 7, further comprising:
a pulley wheel; and
a driving arrangement which comprises the freewheel clutch and the pulley wheel.

12. The hybrid oil pump as recited in claim 11, further comprising:
a belt;
wherein,
the mechanical drive comprises the pulley wheel, and
the pulley wheel is configured to be driven by the belt.
